(19) United States
(12) Patent Application Publication
(10) Pub. No.: US 2025/0326576 A1
(43) Pub. Date: Oct. 23, 2025

(54) CONTAINER ASSEMBLY HAVING RESIDENTIAL REFUSE BIN WASHER SYSTEM FOR A FRONT LOAD REFUSE COLLECTION VEHICLE

(71) Applicant: Perkins Manufacturing Co., Bolingbrook, IL (US)

(72) Inventor: James Rimsa, Shorewood, IL (US)

(21) Appl. No.: 18/643,111

(22) Filed: Apr. 23, 2024

(51) Int. Cl. B65F 7/00; B65F 3/02; B65F 3/04

(52) U.S. Cl. CPC B65F 7/005; B65F 3/041; B65F 2003/0223

(57) ABSTRACT

A container assembly having a residential refuse bin washer system for a front load refuse collection vehicle, the container assembly including a base, a receptacle connected to the base and having side walls, a bottom wall and a drain, the drain being in fluid connection with at least one fluid tank, at least one spray conduit having a distal end extending above the bottom wall, the at least one spray conduit being in fluid connection with at least one fluid tank and at least one fluid pump, and a residential refuse bin lifter assembly, wherein the residential refuse bin lifter assembly is movable between a retracted rest position proximate one of the side walls of the receptacle and a raised and inverted position disposed above the receptacle. The disclosure includes the container assembly in combination with a front load refuse collection vehicle having a container assembly lift apparatus.

### BACKGROUND

### Field of the Disclosure

The present disclosure relates to equipment for washing refuse bins configured for dumping into refuse collection vehicles. More particularly, the present disclosure relates to bin washer systems that lift, invert and wash the inside of a residential refuse bin.

### Description of Related Art

Residential refuse bin washing has become increasingly popular as consumers seek to avoid germs, odors and pests that may be associated with dirty residential refuse containers or bins. Residential refuse bin washing systems presently available are configured as a stationary system or more often are mounted on a trailer or on the rear of a modestly sized truck, with such trailers or trucks being configured solely for residential refuse bin washing.

Residential refuse bin washing systems typically include a pressure washer, water tank and spray nozzle. The systems generally are used by an operator who rolls a residential refuse bin into a position for use by the system. The operator then uses a hydraulic lifter to raise and tip the refuse container into an inverted position over a spray nozzle. The operator then must engage the washing system to dispense fluid from the spray nozzle to wash the inside of the residential refuse bin, which may otherwise be referred to as a refuse container. Operation of the lifter then is reversed to return the washed residential refuse bin to the ground. Because the operator has to personally handle each bin, the process tends to be relatively slow. In addition, the operator generally may be exposed to a risk of working in a road that is subject to traffic.

### SUMMARY

The disclosure pertains to improved container assemblies having residential refuse bin washing systems for a front refuse collection vehicle. The container assemblies may be configured to have numerous advantages. The container assemblies having residential refuse bin washing systems provide much higher utilization of both personnel and equipment.

In some configurations, the container assemblies with residential refuse bin washing systems are used to selectively or temporarily convert a front load refuse collection vehicle into a residential refuse washing vehicle. This provides refuse collection companies unique advantages by which existing refuse collection vehicles may be temporarily or permanently modified and deployed for residential refuse bin washing. Thus, such a container assembly system may be added to an existing waste collection vehicle to run a route to wash residential refuse bins. For example, a front load refuse collection vehicle outfitted with a container assembly having a residential bin washer system may follow behind a regular refuse collection truck that will first empty the bins and thereafter cleanse the bins. If the system is constructed to temporarily modify a vehicle, then the system may be removable, so it may be removed from the vehicle and the vehicle may return to service as a refuse collection vehicle. This results in a dual-purpose vehicle, as opposed to existing systems that are constructed in a manner that requires a vehicle or trailer dedicated to a single use. This permits a company to increase utilization of its refuse collection vehicles, while maintaining a small and adaptable fleet of vehicles.

The container assemblies having a residential refuse bin washing system also provide the unique advantage of being either semi-automated, in which case an operator is outside of the vehicle cab and may even bring bins to the washing system, or may be automated, wherein the operator may remain in the vehicle cab and control the container assembly with bin washer system remotely.

Some communities are set up for automated trash collection. The residents place their bins neatly in a row, where an automated bin lifter may grab a bin while the operator stays safely inside the vehicle cab. The lifter typically may be operated via remote controls, which may include a joystick. This may allow an operator to service one bin after another quickly, while advancing the vehicle from one bin to another and with minimal need to exit the vehicle. With such equipment, residential refuse collection rates may be faster, making the routes more productive and safer. The present container assemblies with residential bin washer systems seek to bring to residential refuse bin washing a similar rate of operation and efficiency.

Thus, the present disclosure provides a container assembly having a residential bin washer system that can be mounted to a typical front load refuse collection vehicle. Once fully installed, that vehicle can wash residential refuse bins at a higher rate of speed than existing stationary systems or manual systems mounted on a trailer or the rear of a smaller, single use truck. This enables service wherein a refuse collection vehicle first empties a bin, and then a vehicle equipped with the residential refuse bin washing system following behind the refuse collection vehicle, stops and sanitizes the empty residential refuse bin with fluid, typically using pressurized water and optionally using heated water and/or detergents.

In the first preferred example shown, the container assembly includes an automated container assembly having a lifter arm mounted to a container. With an automated container assembly, the lifter can reach out to lift and lower a bin while the operator remains in the cab of the vehicle, or if the controls are outside of the cab, the operator at least will not have to manually grasp and manipulate the bin. In later examples, the container assembly may be semi-automatic, which requires an operator to manually bring bins to and from a residential bin lifter assembly connected to a receptacle.

The container assembly could be removable from a vehicle or permanently connected to the vehicle. In the examples shown, the systems preferably include a container having fork pockets for use in removably mounting the container to a set of forks on a front load refuse collection vehicle. It will be appreciated that other removable constructions and connection structures may be employed, such as via quick disconnect assemblies. Alternatively, a container assembly having the residential bin washer system may be permanently mounted to a vehicle that will be dedicated to bin washing.

In one example, a lifter having an automated arm may be controlled via joystick by the operator within the vehicle cab. However, the controls may be external to the vehicle cab and located on or near the container assembly. It also will be appreciated that alternative types of lifters may be used, as shown for example by the lifters in the additional preferred embodiments.

The container assembly includes a receptacle having a bottom wall, which receives wash fluid and debris from washed residential refuse bins. The bottom wall may be sloped to allow for the fluid and debris from the cleaning process to gather at a drain. The drain may direct such fluid to exit to a waste tank or to reenter the system and be filtered before returning to a fluid tank, optionally for reuse in the washing process, or to be collected for later disposal.

The fluid tank is located under the receptacle bottom wall, along with an actuator and at least one fluid pump. The fluid pump feeds fluid from the tank to a spray conduit that extends upward from the bottom wall of the receptacle. The spray conduit may include at least one spray nozzle at a distal end. The nozzle may be fixed in place with outlet ports that are directed in different directions and/or may move, such as by spinning to clean all parts of the inside of a residential refuse bin in just a few moments. Optional additional nozzles may be positioned outside the bin and may spray the exterior handles and outer parts of the bin. Thus, the system optionally may sanitize both the inside and outside of a residential refuse bin.

When the vehicle is not actively washing bins, the front loader arms may be raised to place the container assembly in an inverted position, above or within the collection body of the vehicle. In such inverted position, any debris removed from bins during cleaning and which has accumulated on the bottom wall of the receptacle may fall into the collection body of the vehicle, thereby emptying the receptacle and preparing it for further use in cleaning additional bins.

The system can be configured in many different ways, depending on the needs of the service provider. For example, a fluid heater and/or detergent dispenser optionally may be included, each of which may improve washing performance. Water may be the common or basic fluid used. Also, grey water or dirty fluid collected from the wash process may be either filtered and reused, or sent to one or more separate grey water fluid tanks for disposal, depending on the level of sanitation to be achieved. Therefore, the system may have one fluid tank or a plurality of fluid tanks.

Although the design shows an on-board fluid tank held within a container assembly, it will be appreciated that an external fluid tank may be located in alternative locations. For example, a fluid tank may be located above the vehicle cab, above the collection body, inside the collection body or between the cab and collection body. A hose may be configured to run from an external tank down the vehicle lift arms and to the container assembly pressure washing system. External tanks not adjacent the container assembly may advantageously redistribute some of the weight of the wash system, to avoid having all of the weight carried by the front loader forks of the lift arms, and may allow for one or more fluid tanks having a larger capacity than may otherwise fit beneath the bottom wall of the receptacle.

It will be appreciated that the actuator that powers the fluid pump may be a hydraulic motor, an electric motor or any other suitable equipment capable of driving a fluid pump, and one or more pumps may be used. The filtration system is shown with three filters in line. However, it will be understood that the system alternatively may use any number of filters or there may be no filtration at all. If there is no filtration, the wash fluid typically would be routed directly to a grey water or dirty fluid tank for later disposal.

The present disclosure provides several aspects of the subject matter which may be embodied separately or together in the devices and systems described and claimed herein. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a container assembly having a residential bin washer system for a front load refuse collection vehicle is provided, the container assembly comprising: a base; a receptacle connected to the base and having side walls, a bottom wall and a drain; the drain being in fluid connection with at least one fluid tank; at least one spray conduit having a distal end extending above the bottom wall of the receptacle; the at least one spray conduit being in fluid connection with at least one fluid tank and at least one fluid pump; a residential bin lifter assembly; wherein the residential bin lifter assembly is movable between at least a retracted rest position proximate one of the side walls of the receptacle and a raised and inverted position disposed above the receptacle.

### BRIEF DESCRIPTION OF DRAWINGS

In describing the preferred example embodiments, reference is made to the accompanying drawing figures wherein like parts have like reference numerals, and wherein:

FIG. 1 is a perspective view illustrating a first example front load refuse collection vehicle with a container assembly having a residential refuse bin washer system, with the container assembly positioned on forks of the front-load refuse collection vehicle and shown as it would encounter a series of bins to be washed along a street;

FIG. 2 is a perspective view of the example front load refuse collection vehicle of FIG. 1;

FIG. 3 is a perspective view of the example front load refuse collection vehicle with the container assembly having a residential refuse bin washer system of FIG. 1 with the container assembly in a raised and stowed position in a collection hopper of the vehicle;

FIGS. 4A-4C show perspective, side and front views of a typical ANSI Type G compatible residential refuse bin, typically having a capacity in a range of 64-96 gallons, which are shown in FIG. 1;

FIG. 5 is a perspective view of the exemplary container assembly of FIG. 1, having an automated arm having a bin-gripping assembly which is part of a first residential bin lifter assembly shown in a retracted position;

FIG. 6 is a perspective view of the exemplary container assembly of FIG. 1, with the arm in an extended position and the bin-gripping assembly closed as though it were gripping a residential refuse bin;

FIG. 7 is a perspective view of the exemplary container assembly of FIG. 1, with the arm in a retracted position and having the bin-gripping assembly raised as though it were inverting a residential refuse bin to be in a bin washing position;

FIG. 8 is a perspective view of the container assembly of FIGS. 1, 3 and 5-7, with the arm extended and having the bin-gripping assembly open and reaching for a residential refuse bin to be washed;

FIG. 9 is a perspective view of the container assembly of FIG. 8 with the arm in a raised position with the bin-gripping assembly holding the residential refuse bin in a cleaning position over a spray nozzle;

FIG. 10 is another perspective view of the container assembly and a bin in the cleaning position shown in FIG. 9 but having lower side panels omitted to show otherwise concealed structure and components;

FIG. 11 is an enlarged perspective view of the example container assembly shown in FIG. 10 with more panels omitted to show further concealed structure and components;

FIG. 12 is another enlarged perspective view of the example container assembly shown in FIGS. 10 and 11 with additional components omitted to show further concealed structure and components.

FIG. 13 is a perspective view of a second example container assembly similar to the container assembly of FIG. 5 but having an alternative second residential bin lifter assembly, which typically is for semi-automated use and is shown in a raised and inverted position disposed above the receptacle; and

FIG. 14 is a perspective view of a third example container assembly similar to the container assembly of FIGS. 5 and 13 but having a further alternative third residential bin lifter assembly, which typically is for semi-automated use and is shown in a raised and inverted position disposed above the receptacle

It should be understood that the drawings are not necessarily to scale, with some views enlarged for enhanced viewing. While some details of the example container assembly having a residential refuse bin washer system for a front load refuse collection vehicle, including details of fastening means and other plan and section views of the particular components, may not be shown, such details are considered to be within the comprehension of those skilled in the art in light of the present disclosure. It also should be understood that the present disclosure and claims are not limited to the preferred embodiments illustrated.

### DESCRIPTION OF THE ILLUSTRATED EMBODIMENTS

The embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

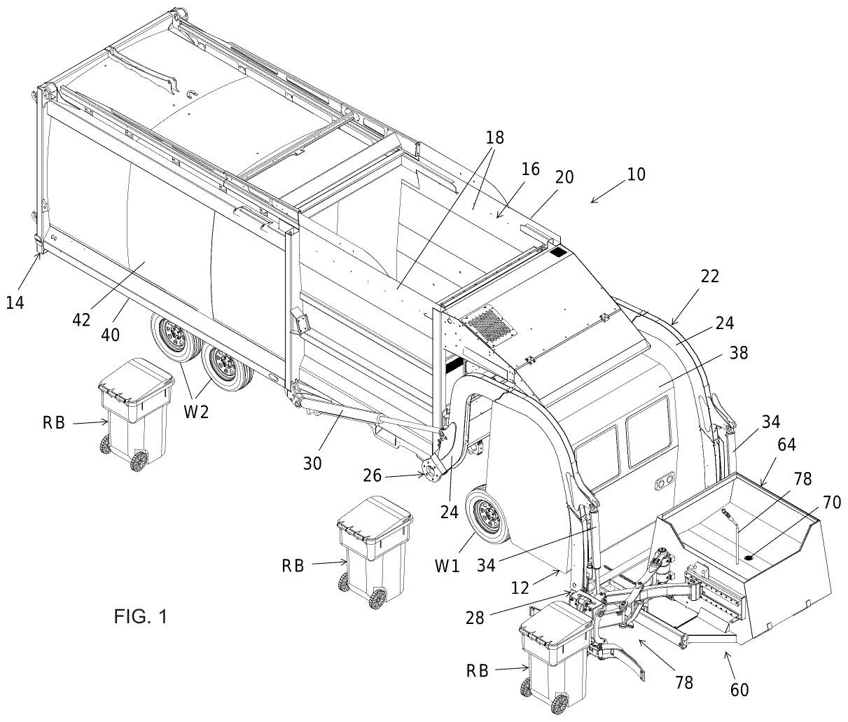

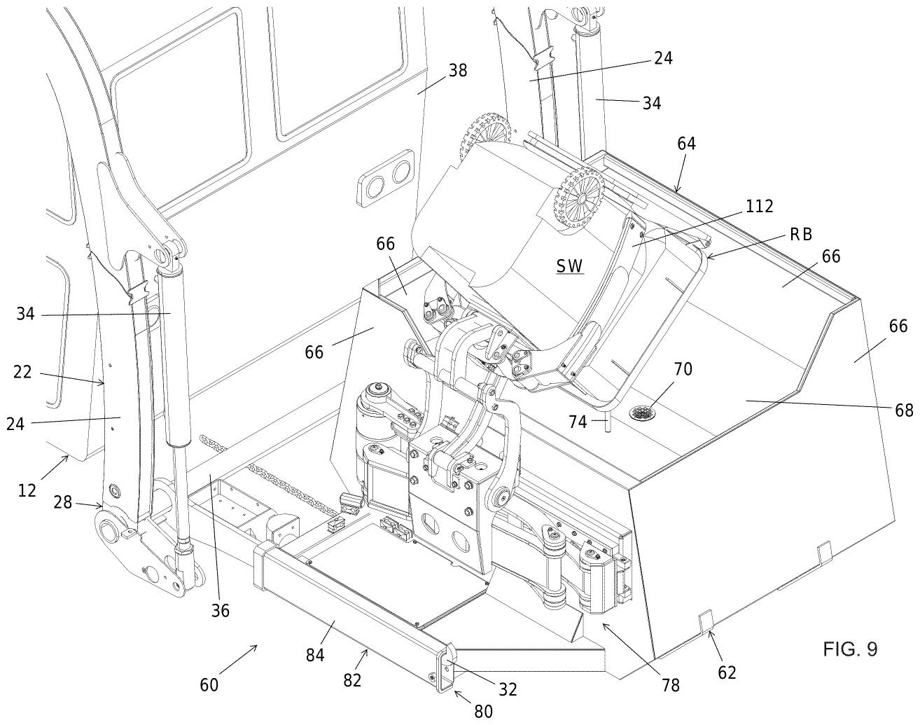

Referring generally to FIGS. 1-14, it will be appreciated that container assemblies having a residential refuse bin washer system for a front load refuse collection vehicle of the present disclosure may be embodied in numerous configurations. Such container assemblies also may be configured for connection to various front load refuse collection vehicles having container assembly lift apparatus. For example, the container assemblies may be removably or permanently connected to refuse collection vehicles. The teachings within this disclosure also pertain to use of residential refuse bin lifter assemblies that may be of various configurations and which may have various bin engaging apparatus to lift and move a residential refuse bin to an inverted position above a receptable to clean the bin.

For instance, FIGS. 1-3 and 5-12 illustrate a first example embodiment of a front load refuse collection vehicle 10 shown in combination with a container assembly 60. The front load refuse collection vehicle 10 has a front end 12 and rear end 14. The vehicle 10 includes a hopper 16 having side walls 18 extending upward to an opening 20 located rearward of the front end 12.

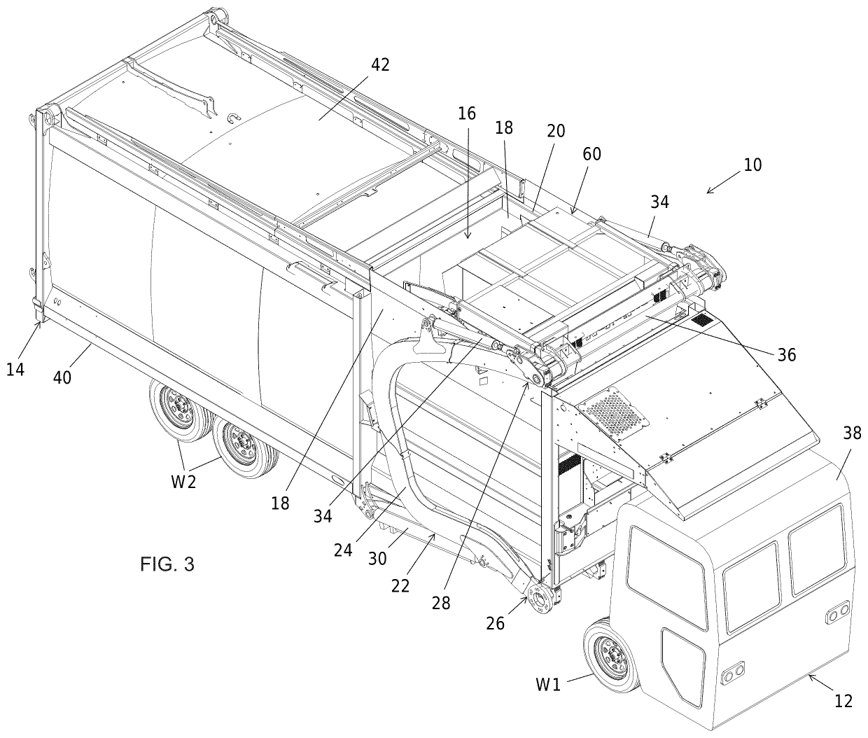

The front load refuse collection vehicle 10 further includes a container assembly lift apparatus 22 to lift and invert the container assembly 60. The container assembly lift apparatus 22 is movable between at least a lowered position (best seen in FIG. 1) wherein the container assembly 60 is disposed forward of the front end 12 of the vehicle 10 and a raised inverted position (best seen in FIG. 3) wherein the container assembly lift apparatus 22 positions at least a portion of the inverted container assembly 60 within the opening 20 of the hopper 16. This second position may be used to stow the container assembly 60 for ease of transit and in FIG. 3 shows the container assembly 60 nearly entirely conveniently received by the hopper 16.

The container assembly lift apparatus 22 includes at least one movable lift arm 24 connected at a first end 26 to the vehicle 10 and connected at a second end 28 to the container assembly 60. It will be appreciated that the example container assembly lift apparatus 22 of the present example includes two such movable lift arms 24.

The at least one movable lift arm 24 is pivotally connected at the first end 26 to the vehicle 10. The container assembly lift apparatus 22 further includes at least one actuator 30 connected to the at least one movable lift arm 24 and to the vehicle 10. The at least one actuator 30 moves the at least one movable lift arm 24 between at least a lowered position (best seen in FIG. 1) extending forward of the front end 12 of the vehicle 10 and a position (such as seen in FIG. 3) extending upward relative to the vehicle 10. It will be appreciated that the at least one actuator 30 may be a hydraulic actuator, such as is shown in FIGS. 1-3, but that alternative actuator structures and configurations may be utilized, such as an electrically driven linear or rotary actuator.

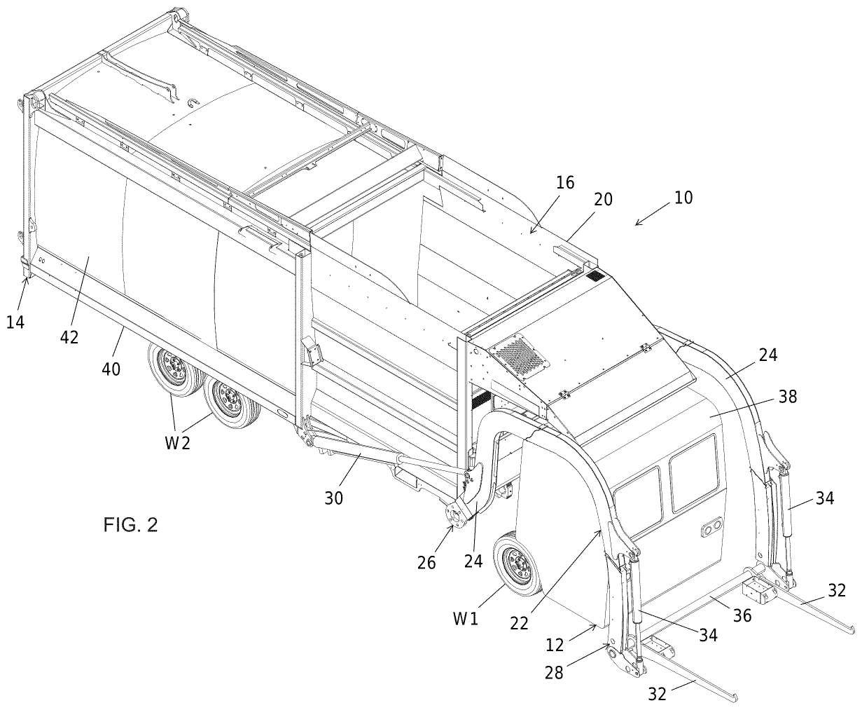

As best seen in FIG. 2, in the present example, the container assembly lift apparatus 22 may further include at least one fork 32 connected to the at least one movable lift arm 24. The container assembly lift apparatus 22 also may include, for example, at least one second actuator 34 connected to the at least one movable lift arm 24 and to the fork 32 to tilt the fork 32 relative to the movable lift arm 24. It will be appreciated that the at least one second actuator 34 may be a hydraulic actuator, such as is shown in FIGS. 1-3, but that alternative actuator structures and configurations may be utilized, such as an electrically driven linear or rotary actuator.

As noted previously and seen in FIGS. 1-3, it will be appreciated that the example container assembly lift apparatus 22 includes two such movable lift arms 24. Each of the two movable lift arms 24 has respective first ends 26 connected to the vehicle 10 and respective second ends 28 rotatably connected to a cross bar assembly 36 having two forks 32.

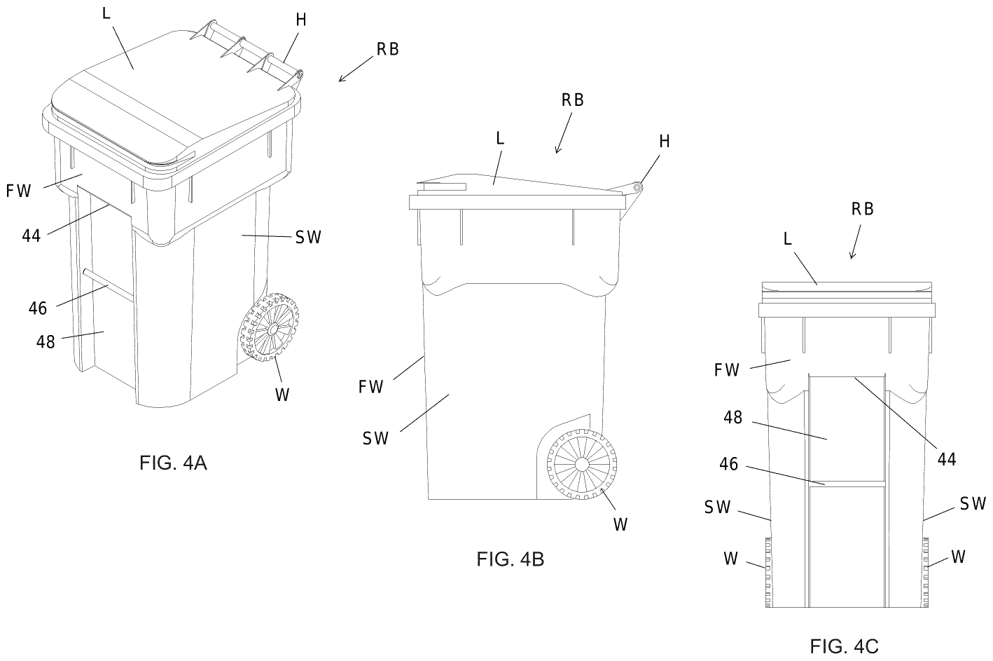

The front load refuse collection vehicle 10 may be of alternative configurations but in this example includes a front operator's cab 38 having wheels W1 and a rear chassis 40 having wheels W2, which supports the hopper 16 and a further refuse collection body 42. While the container assembly 60 may be configured to accommodate different types of residential refuse bins RB, the example embodiments are shown with respect to typical ANSI Type G residential refuse bins, which commonly may have a capacity in a range of 64-96 gallons, and which are shown in FIGS. 1 and 4A-4C.

The residential refuse bins RB may include a grasping portion 44 molded into a front side wall FW and/or a bar 46 across a recess 48 in the front side wall FW. Depending on the bin lifter used, such features provide robust and convenient structures for engaging and lifting a bin with a bin gripper, which may be in the form of a hook. The bin RB commonly will have a pair of wheels W and a lid L hinged at a handle H used to tilt and roll the bin RB. Some lifter configurations may lift a residential refuse bin RB by using gripper arms that engage opposed side walls SW, as is shown in the present example and will be discussed further herein.

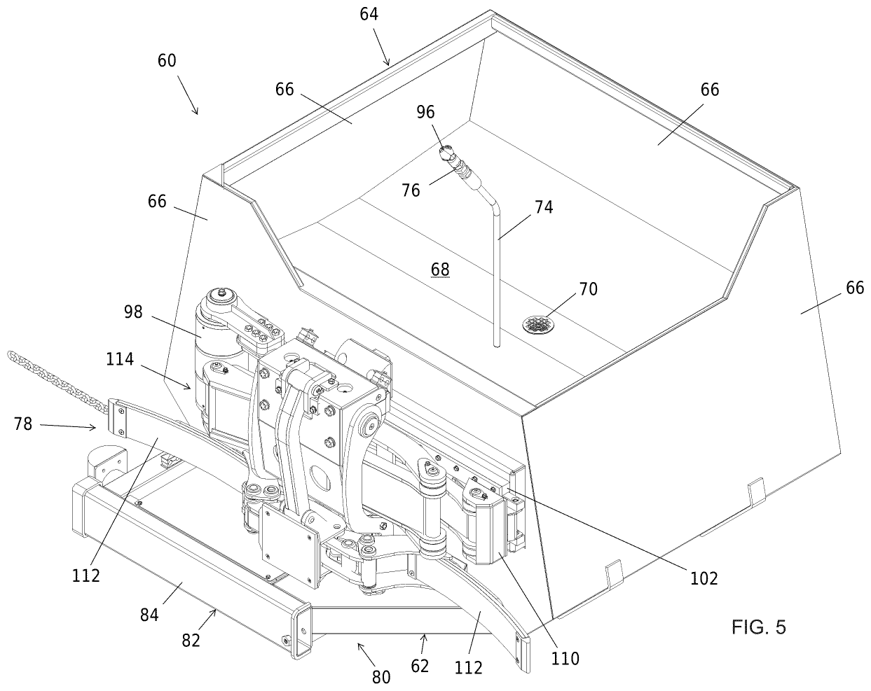

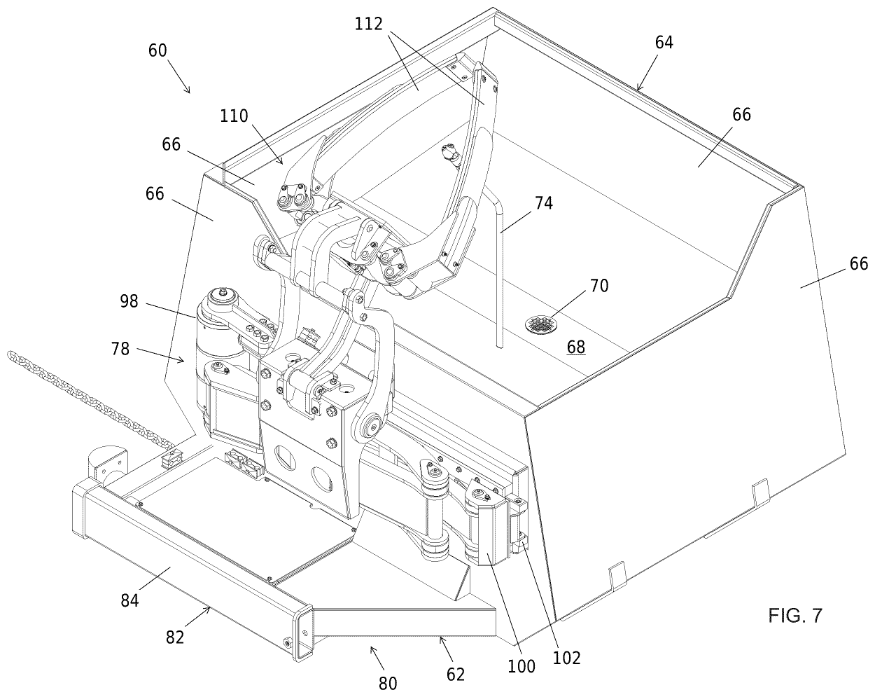

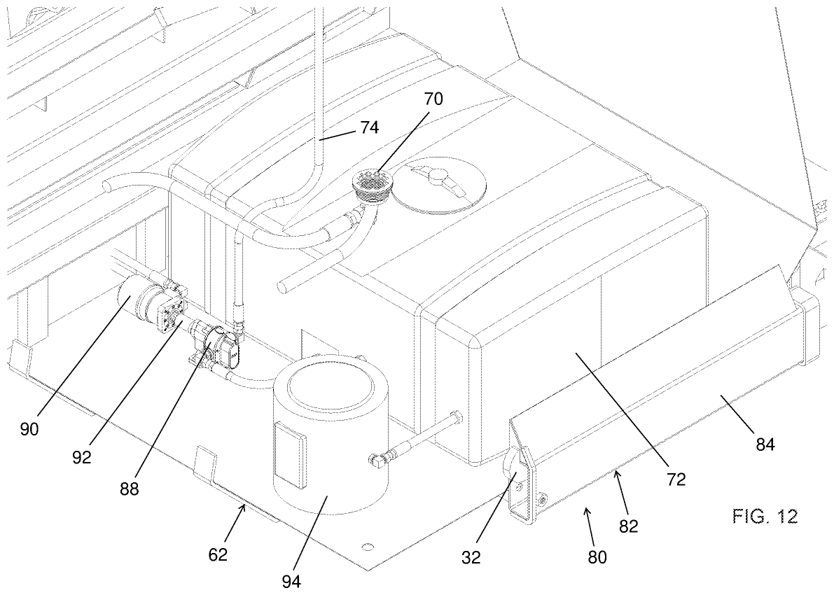

As best seen in FIGS. 1 and 5-12, the disclosure features a first example container assembly 60 having a residential bin washer system for a front load refuse collection vehicle 10. The container assembly 60 includes a base 62, a receptacle 64 connected to the base 62 and having side walls 66, a bottom wall 68 and a drain 70. The drain 70 is in fluid connection with at least one fluid tank 72. There is at least one spray conduit 74 having a distal end 76 extending above the bottom wall 68 of the receptacle 64. The at least one spray conduit 76 is in fluid connection with at least one fluid tank and at least one fluid pump 88, best seen in FIG. 12. In this example, the at least one spray conduit 74 is in fluid connection with the fluid tank 72, but it will be appreciated that the fluid tank in fluid connection with the at least one spray conduit 74 may be connected to a separate, second fluid tank that is not in fluid communication with the drain 70. The container assembly 60 further includes a residential bin lifter assembly 78, wherein the residential bin lifter assembly 78 is movable between at least a retracted rest position proximate one of the side walls of the receptacle 64 (seen in FIG. 5) and a raised and inverted position disposed above the receptacle 64 (seen in FIGS. 7, 9 and 10). The residential bin lifter assembly 78 may have a further intermediate extended position between the retracted position proximate one of the side walls 66 of the receptacle 64 and the raised and inverted position disposed above the receptacle, such as for pickup and release of a bin RB (seen in FIGS. 1, 6 and 8),

The base 62 of the container assembly 60 may include at least one front load refuse collection vehicle mounting assembly 80. The at least one front load refuse collection vehicle mounting assembly 80 may further include at least one releasable connector 82, which may be configured as at least one fork pocket 84. In the example shown, the base 62 includes two fork pockets 84, which receive forks 32 of the container assembly lift apparatus 22 on the front load refuse collection vehicle 10.

As previously noted, in the preferred embodiment shown, the at least one fluid tank in fluid connection with the drain 70 and the at least one fluid tank in fluid connection with the at least one spray conduit 74 comprise the same fluid tank 72. However, it will be appreciated that the fluid tank in fluid connection with the at least one spray conduit 74 may be a separate tank from the at least one fluid tank in fluid connection with the drain 70. It also will be appreciated that the at least one spray conduit 74 may be a single spray conduit or may include two or more spray conduits, and they may be connected to one or more fluid pumps 88. Indeed, it will be appreciated that as another alternative, the container assembly may include more than one bin lifter or a lifter with capacity to lift more than one bin, in which case multiple spray conduits may be used to clean multiple residential refuse bins RB.

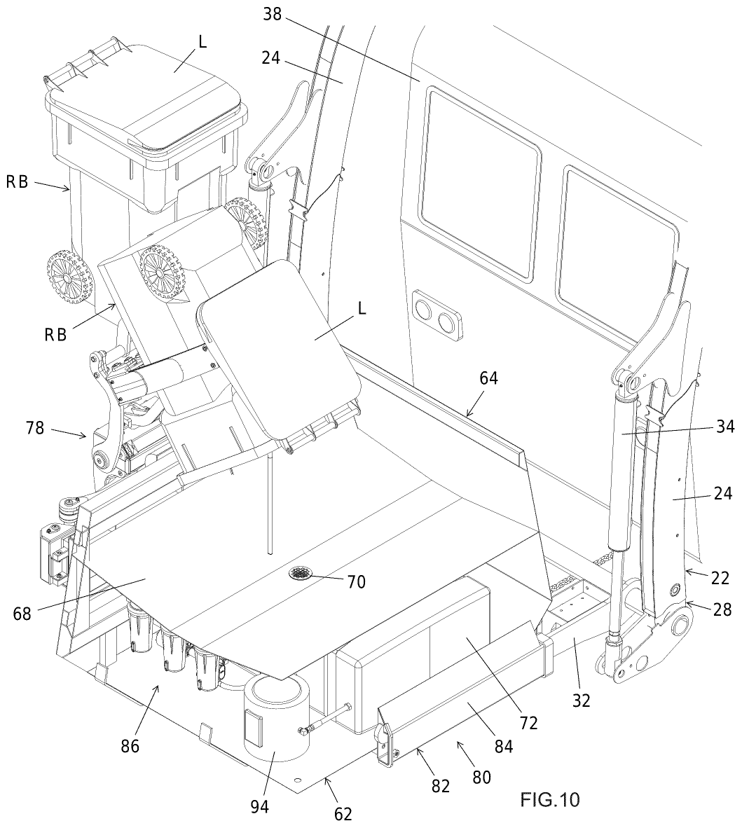

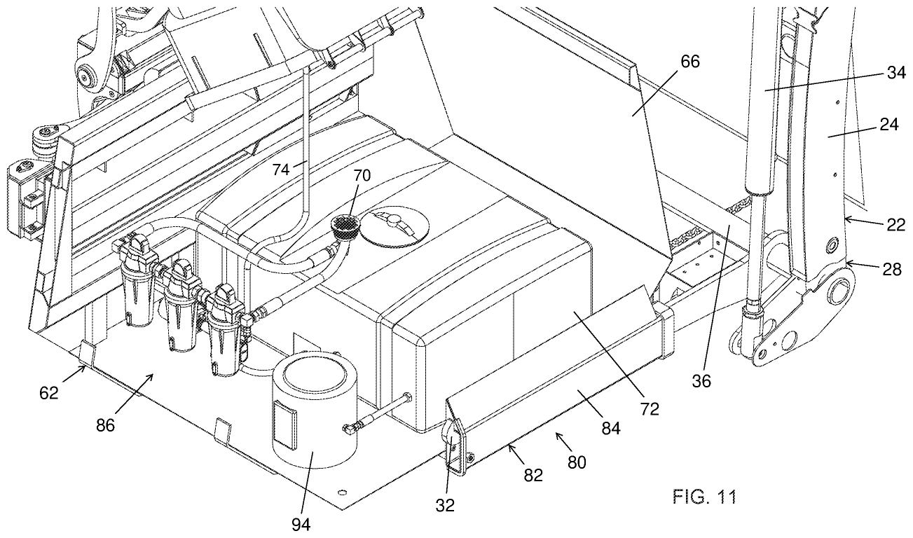

To assist in the cleaning process, especially when using a common or single fluid tank 72, the container assembly 60 may further include a fluid filtration system 86 in fluid connection between the drain 70 and the at least one fluid tank 72 in fluid connection with the drain 70. For example, the filtration system 86 is shown in FIGS. 10-11 with three filters connected in series and having an inlet in fluid connection with the drain 70, while having an outlet in fluid connection with the fluid tank 72.

As best seen in FIG. 12, the container assembly 60 also includes a fluid pump 88 in fluid connection between the at least one spray conduit 74 and the at least one fluid tank 72 in fluid connection with the at least one spray conduit 74. Thus, whether the fluid tank 72 contains fresh cleaning fluid or previously used, filtered cleaning fluid, the fluid pump 88 will move the fluid through the system to be discharged by the at least one spray conduit 74 to clean one or more residential refuse bins RB. The fluid pump 88 of the example shown is configured to be driven by an actuator 90, which may be hydraulically or electrically powered. The actuator 90 is connected to the fluid pump 88 via a coupling 92, but it will be appreciated that other configurations of fluid pumps and drive mechanisms may be utilized.

Performance of the container assembly 60 with a bin washer system may be enhanced by inclusion of a fluid heater 94, such as is shown in FIGS. 10-12. The fluid heater 94 is in fluid connection between the at least one fluid tank 72 in fluid connection with the at least one spray conduit 74 and the at least one spray conduit 76. If utilizing a fluid heater 94, the fluid pump 88 may be in fluid connection between the fluid heater 94 and the at least one spray conduit 74.

It will be appreciated that with the example container assembly 60 shown, the at least one spray conduit 74 extends upward from the bottom wall 68 of the receptacle 64. However, the at least one spray conduit may be otherwise configured, for example, to extend into an inverted bin RB, such as by extending from a side wall 66 of the receptacle 64. The spray conduit would still have a distal end extending above the bottom wall 68 of the receptacle 64.

The container assembly 60 may have at least one fluid tank 72 connected to the at least one spray conduit 74, with the at least one fluid tank 72 located remotely from the at least one spray conduit 74. In the example seen in FIGS. 10-12, the at least one fluid tank 72 is located remotely from the at least one spray conduit 74 by being located below the bottom wall 68 of the receptacle 64. Indeed, as noted above, the at least one fluid tank in fluid connection with the at least on spray conduit of the container assembly alternatively may be disposed in a still more remote location, for example, whether adjacent a side wall of the receptacle or proximate the vehicle cab 38 or refuse collection body 42.

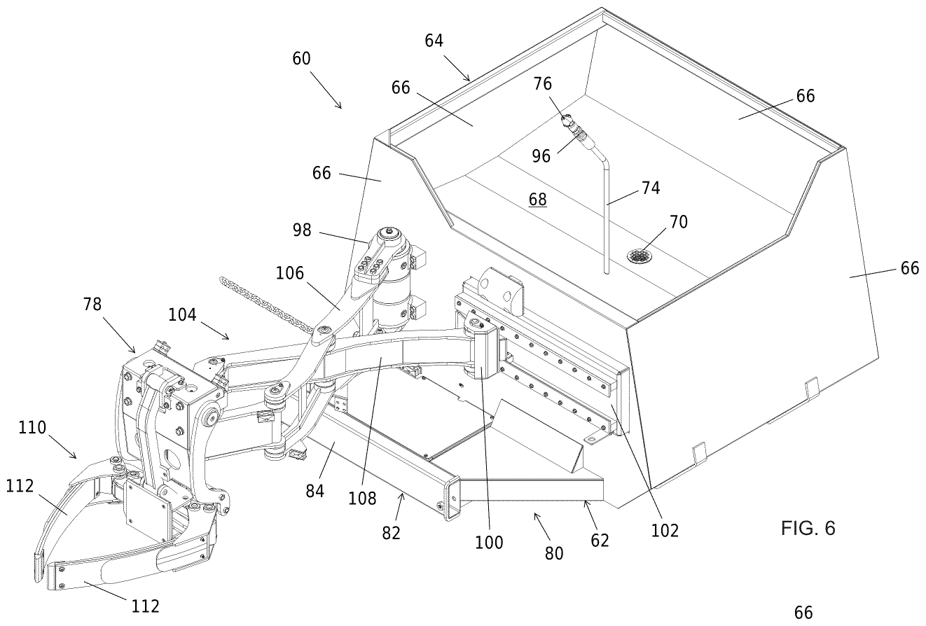

To adequately discharge the cleaning fluid and sanitize the residential refuse bins RB, the at least one spray conduit 74 of the container assembly 60 may include at least one spray nozzle 96 at the distal end 78. An example spray nozzle 96 is shown in FIGS. 5-6. Such a spray nozzle 96 may be fixed in position and configured to spray in a plurality of directions or may be configured to move, such as to spin while discharging cleaning fluid.

As seen in FIGS. 5-9, the residential bin lifter assembly 78 of the container assembly 60 is connected to the base 62. More particularly in the example shown, the residential bin lifter assembly 78 is connected to the base 62 via mounting to a side wall 66 of the receptacle 64. It will be appreciated that the residential bin lifter assembly 78 pivots relative to the receptacle 64, so as to be able to move a bin RB from a ground level position to an inverted position over the receptacle 64. In the example shown, the residential bin lifter assembly 78 includes a pivotal connection to the receptacle 64. The pivotal connection is embodied in two structures, namely, via an actuator 98 that causes movement of the residential bin lifter assembly 78 and via a pivot block 100, which translates in a track 102 connected to a side wall of 66 of the receptacle 64. The actuator 98 of the example residential bin lifter assembly 78 is shown as a rotary actuator, such as may be hydraulically or electrically powered.

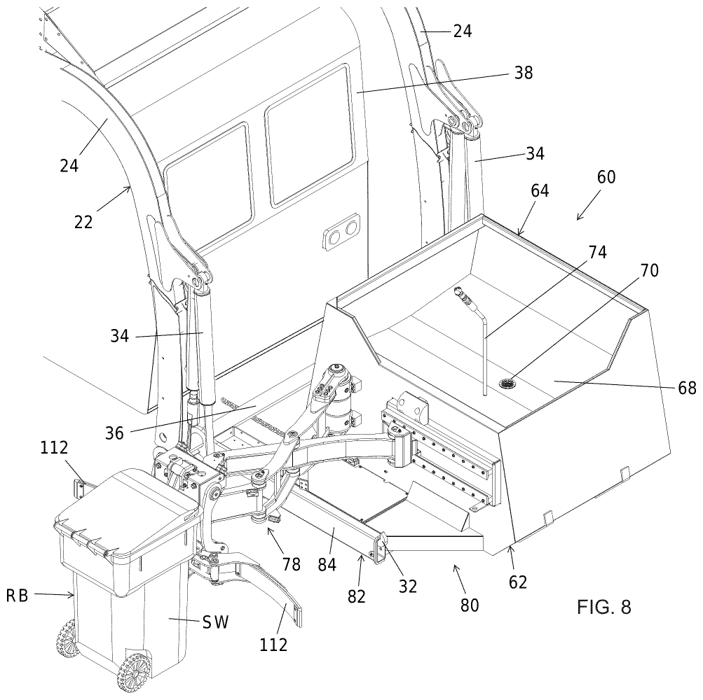

The residential bin lifter assembly 78 of this first example includes an extendable linkage 104. The extendible linkage 104 is connected via a first arm 106 to the actuator 98 and via a second arm 108 to the pivot block 100. At the opposite end of the extendible linkage 104, the residential bin lifter assembly 78 further comprises a bin gripper 110, having gripper arms 112. The gripper arms 112 are configured to be able to grasp a residential refuse bin RB while on a ground surface and to be able to lift and invert the bin RB to a position over the spray conduit 74. The residential bin lifter assembly 78 is movable from a retracted rest position proximate one of the side walls 66, as seen in FIG. 5, to a raised and inverted position disposed above the receptacle 64, as seen in FIGS. 7, 9 and 10. This residential bin lifter assembly also includes at least one intermediate extended position between the retracted position proximate one of the side walls 66 of the receptacle 64 and the raised and inverted position disposed above the receptacle 64. The intermediate extended position can be used to pickup and release a bin, as seen in FIGS. 1 and 8, where the bin gripper 110 may engage, grasp (and later release) the bin RB using the gripper arms 112.

As conveyed in FIGS. 1-3 and 8-12, and appreciated in view of the above description, the container assembly 60 is used in combination with a front load refuse collection vehicle 10 having a container assembly lift apparatus 22. The structures and interconnection between the container assembly 60 and the container assembly lift apparatus 22 of the front load refuse collection vehicle 10 are described above. For example, as previously described, the front load refuse collection vehicle 10 includes a front end 12 and a hopper 16 having side walls 18 extending upward to an opening 20 located rearward of the front end 12. The container assembly lift apparatus 22 is movable between at least a lowered position wherein the container assembly 60 is disposed forward of the front end 12 of the vehicle 10 and a raised inverted position wherein the container assembly lift apparatus 22 positions at least a portion of the inverted container assembly 60 within the hopper opening 20. In this manner, the container assembly 60 facilitates a convenient and efficient modification of a front load refuse collection vehicle to also provide for residential bin washing.

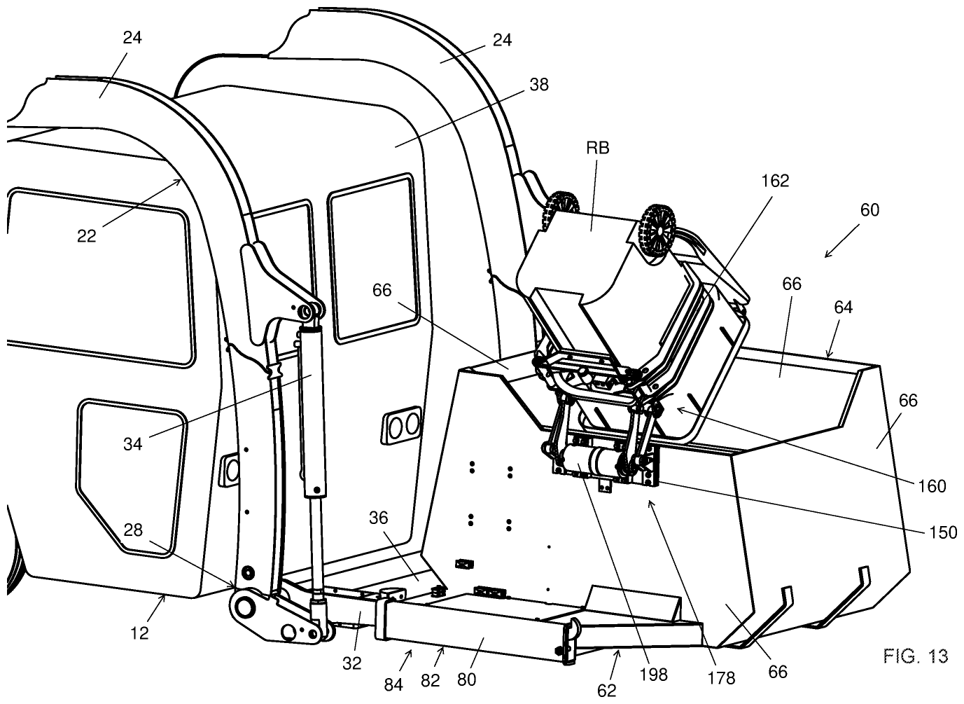

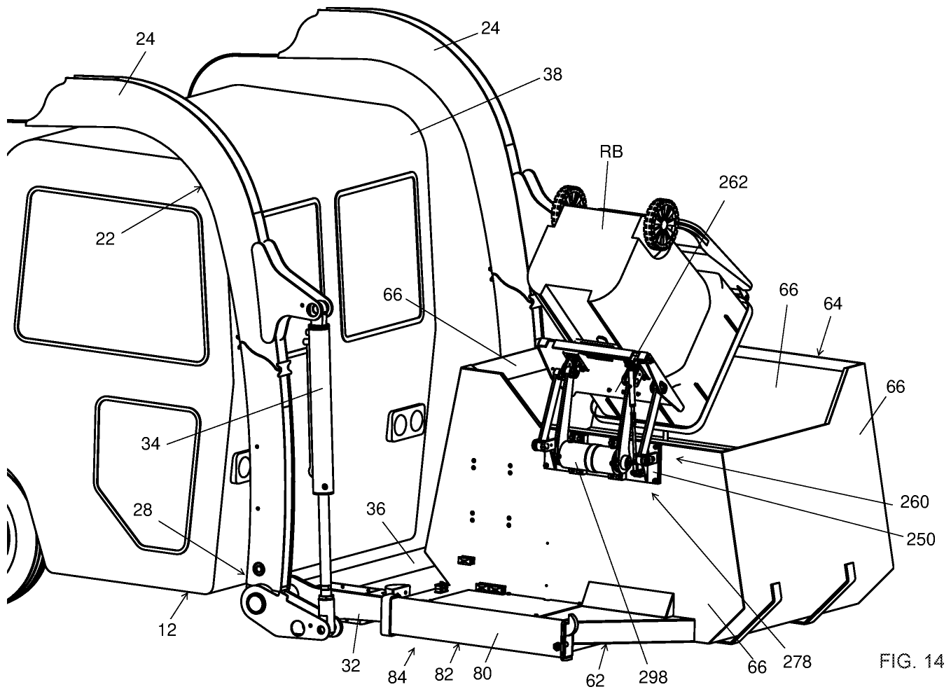

As noted above, it will be appreciated that the first example embodiment of a container assembly has a residential bin lifter assembly 78 which may be equipped and incorporated into an automated system having extendible linkage that is capable of extending to pickup and release residential bins RB with gripper arms. However, alternative residential bin lifter assemblies may be used, such as residential bin lifter assemblies 178 and 278, of FIGS. 13 and 14, respectively. These example residential bin lifter assemblies 178 and 278 would be appropriate for use in a semi-automated manner, wherein an operator must bring a residential bin to the lifter.

FIG. 13 shows a second example version of the container assembly 60 having a residential bin washer system for a front load refuse collection vehicle 10, which differs from the first example by substitution of the example residential bin lifter assembly 178, for the residential bin lifter assembly 78. The container assembly 60 is otherwise the same as previously described, but is configured to be semi-automated. Thus, the preceding description of the other components and operation applies and will not be repeated.

It will be appreciated that the residential bin lifter assembly 178 is movable between at least a retracted rest position proximate one of the side walls of the receptacle 64 and a raised and inverted position disposed above the receptacle 64 (seen in FIG. 13). The residential bin lifter assembly 178 lacks a further intermediate extended position between the retracted position proximate one of the side walls 66 of the receptacle 64 and the raised and inverted position disposed above the receptacle, so its pickup and release of a bin RB differs from that of the residential bin lifter assembly 78.

As seen in FIG. 13, the residential bin lifter assembly 178 of the second example container assembly 60 is connected to the base 62, such as via mounting to a side wall 66 of the receptacle 64. It will be appreciated that the residential bin lifter assembly 178 pivots relative to the receptacle 64, so as to be able to move a bin RB from a ground level position to an inverted position over the receptacle 64. In the second example shown, the residential bin lifter assembly 178 includes a pivotal connection to the receptacle 64. The pivotal connection is embodied in an actuator 198 that causes movement of the residential bin lifter assembly 178 and is connected to the side wall 66 via a mounting block 150. The actuator 198 of the example residential bin lifter assembly 178 is shown as a rotary actuator, such as may be hydraulically or electrically powered.

The residential bin lifter assembly 178 of this second example includes linkage 154 connected to the actuator 198 and a bin gripper 160, having gripper arms 162. The gripper arms 162 are configured to be able to grasp a residential refuse bin RB while on a ground surface and to be able to lift and invert the bin RB to a position over the spray conduit 74. The residential bin lifter assembly 178 is movable from a retracted rest position proximate one of the side walls 66 to a raised and inverted position disposed above the receptacle 64, as seen in FIG. 13. This residential bin lifter assembly typically would be semi-automated because an operator would bring a residential bin RB close to the lifter assembly 178 in the retracted rest position to enable the bin to be picked up by the bin gripper 160 without having to reach a significant distance from the receptacle 64. As will be appreciated from FIG. 13, the bin gripper 160 may engage, grasp (and later release) the bin RB using the gripper arms 162 of the gripper 160 and the actuator 198.

As conveyed in FIG. 13, and appreciated in view of the above description, the container assembly 60 having the residential bin lifter assembly 178 is used in combination with a front load refuse collection vehicle 10 having a container assembly lift apparatus 22. The structures and interconnection between the container assembly 60 and the container assembly lift apparatus 22 of the front load refuse collection vehicle 10 are described above. In a similar manner, the container assembly 60 using the second example residential bin lifter assembly 178 facilitates a convenient and efficient modification of a front load refuse collection vehicle to also provide for residential bin washing.

Turning to FIG. 14, a third example version of the container assembly 60 having a residential bin washer system for a front load refuse collection vehicle 10 is shown and differs from the first example by substitution of the residential bin lifter assembly 278, for the residential bin lifter assembly 78. Once again, the container assembly 60 is otherwise the same as previously described, but is configured to be semi-automated. Thus, the preceding description of the other components and operation applies and will not be repeated.

It will be appreciated that the residential bin lifter assembly 278 is movable between at least a retracted rest position proximate one of the side walls of the receptacle 64 and a raised and inverted position disposed above the receptacle 64 (seen in FIG. 14). The residential bin lifter assembly 278 lacks a further intermediate extended position between the retracted position proximate one of the side walls 66 of the receptacle 64 and the raised and inverted position disposed above the receptacle, so its pickup and release of a bin RB differs from that of the residential bin lifter assembly 78.

As seen in FIG. 14, the residential bin lifter assembly 278 of the third example container assembly 60 is connected to the base 62, such as via mounting to a side wall 66 of the receptacle 64. It will be appreciated that the residential bin lifter assembly 278 pivots relative to the receptacle 64, so as to be able to move a bin RB from a ground level position to an inverted position over the receptacle 64. In the third example shown, the residential bin lifter assembly 278 includes a pivotal connection to the receptacle 64. The pivotal connection is embodied in an actuator 298 that causes movement of the residential bin lifter assembly 278 and is connected to the side wall 66 via a mounting block 250. The actuator 298 of the example residential bin lifter assembly 278 is shown as a rotary actuator, such as may be hydraulically or electrically powered.

The residential bin lifter assembly 278 of this third example includes linkage 254 connected to the actuator 298 and a bin gripper 260, having gripper hook 262 connected to the front of the plate at the location of the fasteners seen in FIG. 14. The gripper hook 262 is configured to be able to grasp a residential refuse bin RB at the grasping portion 44 molded into the front side wall FW and/or the bar 46 across the recess 48 in the front side wall FW, while on a ground surface and to be able to lift and invert the bin RB to a position over the spray conduit 74. The residential bin lifter assembly 278 is movable from a retracted rest position proximate one of the side walls 66 to a raised and inverted position disposed above the receptacle 64, as seen in FIG. 14. This residential bin lifter assembly typically would be semi- automated because an operator would bring a residential bin RB close to the lifter assembly 278 in the retracted rest position to enable the bin to be picked up by the bin gripper 260 without having to reach a significant distance from the receptacle 64. As will be appreciated from FIG. 14, the bin gripper 260 may engage, grasp (and later release) the bin RB using the gripper hook 262 of the bin gripper 260 and the actuator 298.

As conveyed in FIG. 14, and appreciated in view of the above description, the container assembly 60 having the residential bin lifter assembly 278 is used in combination with a front load refuse collection vehicle 10 having a container assembly lift apparatus 22. The structures and interconnection between the container assembly 60 and the container assembly lift apparatus 22 of the front load refuse collection vehicle 10 are described above. In a similar manner, the container assembly 60 using the third example residential bin lifter assembly 278 facilitates a convenient and efficient modification of a front load refuse collection vehicle to also provide for residential bin washing.

It will be appreciated that a container assembly having a residential bin washer system for a front load refuse collection vehicle may include different configurations to suit alternative vehicles, residential refuse bins and bin lifter assemblies to those shown. Accordingly, as noted, the embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

1. A container assembly having a residential refuse bin washer system for a front load refuse collection vehicle, the container assembly comprising:
a base;
a receptacle connected to the base and having side walls, a bottom wall and a drain;
the drain being in fluid connection with at least one fluid tank;
at least one spray conduit having a distal end extending above the bottom wall of the receptacle;
the at least one spray conduit being in fluid connection with at least one fluid tank and at least one fluid pump;
a residential refuse bin lifter assembly;
wherein the residential refuse bin lifter assembly is movable between a retracted rest position proximate one of the side walls of the receptacle and a raised and inverted position disposed above the receptacle.

2. The container assembly of claim 1, wherein the base further comprises at least one front load refuse collection vehicle mounting assembly.

3. The container assembly of claim 2, wherein the at least one front load refuse collection vehicle mounting assembly further comprises at least one releasable connector.

4. The container assembly of claim 3, wherein the at least one releasable connector further comprises at least one fork pocket.

5. The container assembly of claim 1, wherein the at least one fluid tank in fluid connection with the drain and the at least one fluid tank in fluid connection with the at least one spray conduit comprise the same fluid tank.

6. The container assembly of claim 1, further comprising a fluid filtration system in fluid connection between the drain and the at least one fluid tank in fluid connection with the drain.

7. The container assembly of claim 1, further comprising a fluid heater in fluid connection between the at least one fluid tank in fluid connection with the at least one spray conduit and the at least one spray conduit.

8. The container assembly of claim 1, wherein the at least one spray conduit extends upward from the bottom wall of the receptacle.

9. The container assembly of claim 1, wherein the at least one fluid tank connected to the at least one spray conduit is located remotely from the at least one spray conduit.

10. The container of claim 9, wherein the remotely located at least one fluid tank connected to the at least one spray conduit is disposed below the bottom wall of the receptacle.

11. The container assembly of claim 1, wherein the at least one spray conduit further comprises at least one spray nozzle at the distal end.

12. The container assembly of claim 1, wherein the residential refuse bin lifter assembly is connected to the base.

13. The container assembly of claim 12, wherein the residential refuse bin lifter assembly is connected to the base via mounting to one of the side walls of the receptacle.

14. The container assembly of claim 12, wherein the residential refuse bin lifter assembly pivots relative to the receptacle.

15. The container assembly of claim 12, wherein the residential refuse bin lifter assembly further comprises a pivotal connection to the receptacle.

16. The container assembly of claim 1, wherein the residential refuse bin lifter assembly further comprises extendable linkage.

17. The container assembly of claim 1, wherein the residential bin lifter assembly is further movable to an intermediate extended position between the retracted position proximate one of the side walls of the receptacle and the raised and inverted position disposed above the receptacle.

18. The container assembly of claim 1, wherein the residential refuse bin lifter assembly further comprises a residential refuse bin gripper.

19. The container assembly of claim 1, wherein the bin gripper further comprises gripper arms or a gripper hook.

20. The container assembly of claim 1 in combination with a front load refuse collection vehicle having a container assembly lift apparatus.

21. The combination of claim 20, wherein the front load refuse collection vehicle further comprises a front end and a hopper having side walls extending upward to an opening located rearward of the front end.

22. The combination of claim 21, wherein the container assembly lift apparatus is movable between at least a lowered position wherein the container assembly is disposed forward of the front end of the vehicle and a raised inverted position wherein the container assembly lift apparatus positions at least a portion of the inverted container assembly within the hopper opening.

23. The combination of claim 22, wherein the container assembly lift apparatus further comprises at least one movable lift arm connected at a first end to the vehicle and connected at a second end to the container assembly.

24. The combination of claim 23, wherein the at least one movable lift arm is pivotally connected at the first end to the vehicle.

25. The combination of claim 24, wherein the container assembly lift apparatus further comprises at least one actuator connected to the at least one movable lift arm and to the vehicle.

26. The combination of claim 25, wherein the at least one actuator moves the at least one movable lift arm between at least a lowered first position extending forward of the front end of the vehicle and a second position extending upward relative to the vehicle.

27. The combination of claim 26, wherein the at least one actuator is a hydraulic actuator.

28. The combination of claim 20, wherein the base further comprises at least one front load refuse collection vehicle mounting assembly that connects to the container assembly lift apparatus.

29. The combination of claim 28, wherein the at least one front load refuse collection vehicle mounting assembly of the base further comprises at least one fork pocket and the container assembly lift apparatus further comprises at least one fork received by the fork pocket.

30. The combination of claim 20, wherein the container assembly lift apparatus further comprises at least one movable lift arm connected at a first end to the vehicle and connected at a second end to the container assembly wherein the at least one connector that connects to the container assembly further comprises a fork connected to the at least one movable lift arm.

31. The combination of claim 30, wherein the container assembly lift apparatus further comprises at least one second actuator connected to the at least one movable lift arm and to the fork to tilt the fork relative to the movable lift arm.

32. The combination of claim 31, wherein the at least one second lift actuator is a hydraulic actuator.

33. The combination of claim 30, wherein the container assembly lift apparatus further comprises two movable lift arms having respective first ends connected to the vehicle and respective second ends rotatably connected to a cross bar assembly having two forks.

34. The combination of claim 33, wherein the base further comprises two fork pockets that receive the two forks, respectively.
